(19) United States
(12) Patent Application Publication
(10) Pub. No.: US 2024/0047710 A1
(43) Pub. Date: Feb. 8, 2024

(54) MODULAR FLOW FRAME FOR AN ELECTROCHEMICAL CELL, FLOW FRAME ELECTRODE UNIT, CELL, CELL STACK, AND METHOD FOR PRODUCING A FLOW FRAME

(71) Applicant: J. SCHMALZ GMBH, Glatten (DE)

(72) Inventors: Andreas SCHIEGL, Oberhaching (DE); Udo MARTIN, Freudenstadt (DE); Lars KÜHNLE, Egenhausen (DE); Christian TEUFEL, Rottenburg am Neckar (DE)

(21) Appl. No.: 18/266,905

(22) PCT Filed: Dec. 9, 2021
(86) PCT No.: PCT/EP2021/085021

§ 371 Date: Jun. 13, 2023

(30) Foreign Application Priority Data
Dec. 18, 2020 (DE) 10 2020 134 157.1

(51) Int. Cl. H01M 8/0273; H01M 8/18; H01M 8/2455

(52) U.S. Cl. CPC H01M 8/0273; H01M 8/188; H01M 8/2455

(57) ABSTRACT

The invention relates to a modular flow frame 10 for an electrochemical cell, in particular for a cell of a redox flow battery stack, comprising a main frame body 14, which defines a frame opening 18, wherein the main frame body has a preferably substantially U-shaped cross-sectional profile which is open on one side in the direction of the frame opening, so that a profiled receiving space 26 open toward the frame opening is formed, moreover comprising an insert 16 which is arranged in the profiled receiving space of the main frame body, the insert having channel structures for distributing fluids in the frame opening. The invention further relates to a flow frame electrode unit, a cell, a cell stack and a method for producing a flow frame.

The invention relates to a modular flow frame for an electrochemical cell, in particular for a redox flow battery stack. The invention also relates to a flow frame electrode unit, a cell, a cell stack and a method for producing a flow frame.

Redox flow batteries are electrochemical energy stores with flowable, in particular liquid, storage media in which a redox-active material or a redox-active substance is dissolved in a liquid electrolyte. The electrolytes (referred to as anolyte or catholyte depending on the polarity) are provided separately, for example stored in separate tanks and supplied as required to an electrochemical energy converter unit (the so-called cell of the redox flow battery) for the charging or discharging process. During the charging or discharging process, the redox-active materials are oxidized and reduced in separate half-cells in the cell. Chemical energy is converted into electrical energy during the discharging process and electrical energy is converted back into chemical energy during the charging process. An advantage of redox flow batteries is in particular that power (number and size of the electrochemical energy converters/cells) and capacity (electrolyte volume, size and number of tanks) can be adjusted independently of one another, so that central and decentralized storage systems can be realized on a scale of a few kilowatts to megawatts.

A redox flow battery usually comprises a plurality of structurally identical cells which are fluidically connected in parallel and electrically connected in series. The cells are in particular joined to form a stack, the so-called cell stack, and pressed via a bracing system and, if necessary, braced by means of tie rods. The bracing system usually comprises end plates made of plastic and/or non-ferrous metals such as aluminum, between which the individual cells are arranged. In addition, the bracing system can have plastic insulating plates for separating the current-conducting individual cells from the end plates, current collectors with electrical connections for discharging or supplying the charging or discharging current, and media connections for supplying and discharging the electrolyte (anolyte/catholyte).

For the electrical connection of the individual cells to one another, a so-called bipolar plate, for example made of a graphite-plastic composite material, is usually arranged between two individual cells. Each individual cell is in turn constructed from two half-cells separated by an ion-conducting membrane. The half-cells in turn generally comprise a flow frame and an electrode on which the redox processes take place. In a cell stack, the individual components are stacked between the end plates in the following order: bipolar plate, flow frame with electrode, membrane, flow frame with electrode, bipolar plate, flow frame with electrode, etc.

Together with the electrodes, the flow frames define the actual effective space of a respective half-cell, i.e., the active region in which the electrochemical processes take place. The flow frames fulfill several functions. In particular, the flow frames are used, on the one hand, to fluidically seal the effective space off from the environment with the aid of seals integrated in the flow frame surfaces (sealing function), and on the other hand, to electrically insulate the half-cells of a cell from one another (insulating function). In addition, the flow frames generally comprise integrated flow channels for supplying, discharging and distributing the electrolyte in the effective space of the cell (fluid distributor function).

US 2018/0062188 A1, for example, discloses one-piece, planar flow frames which comprise integrated flow channels for supplying and discharging electrolyte and for areal distribution of the electrolyte in the effective space of the cell. US 2016/0006046 A1 also discloses a one-piece flow frame made of an elastomer material, in which distribution channel structures for the electrolyte are incorporated. Due to their construction, the known flow frames are comparatively complicated to produce. Usually such flow frames are produced by machining (milling, drilling, etc.) or by means of injection-molding or injection-embossing processes. While machining is comparatively time-consuming and cost-intensive due to the high outlay in terms of apparatus and long machine running times, disadvantages of injection molding methods are mainly high investment costs for tools and high technological challenges with regard to shaping, flatness, dimensional accuracy, surface quality, etc. In particular in the case of injection molding methods, the size of the flow frame and specific configuration of the channel structures are determined by the injection molding tool used and cannot be changed without a greater investment outlay.

The present invention addresses the object of enabling a configuration that is flexibly adaptable to different requirements for a redox flow battery. In particular, a flow frame is to be provided which can be produced cost-effectively and can be adapted flexibly to different requirements.

This object is achieved by a flow frame having the features of claim 1. The flow frame is designed for use in an electrochemical cell, in particular for use in a cell of a redox flow battery.

The flow frame has a modular design and comprises a main frame body, which defines a, preferably central, frame opening. In particular, the frame opening defines the actual effective space of the cell.

The main frame body has, when viewed in the circumferential direction around the frame opening, at least in some portions a cross-sectional profile open on one side, namely in the direction of the frame opening, so that a profiled receiving space which is open toward the frame opening is formed. The profiled receiving space can in particular completely or partially encircle the frame opening.

The flow frame also comprises an insert which is arranged in the profiled receiving space of the main frame body. In this respect, the profiled receiving space forms in particular a kind of receiving pocket for the insert. The insert is designed separately in particular insofar as the insert is provided as a separate element and is then inserted into the profiled receiving space to assemble the flow frame.

The insert comprises channel structures for, in particular areal, distribution of fluids in the frame opening. In particular, the insert comprises channel structures for the areal distribution of electrolyte liquid in the effective space. The channel structures can preferably be in the shape of a comb or fan, which enables a homogeneous distribution of a fluid, in particular of electrolyte liquid, in the frame opening. In particular, the insert additionally has channel structures for supplying and/or discharging the fluid. For this purpose, it can also be advantageous if the main frame body has corresponding fluid channels for feeding the channel structures of the insert, in particular in the form of bores.

The insert serves as a spacer within the profiled receiving space and for distributing the electrolyte liquid in the effective space. In particular, the insert can be loosely inserted into the profiled receiving space, that is to say can be joined to the main frame body in a non-destructively detachable manner. However, it is also conceivable for the insert to be integrally bonded to the main frame body, for example by welding and/or gluing. The insert can completely or partially encircle the frame opening. The insert can be designed in particular in the form of a single-piece or multi-part insert frame. The insert is preferably accommodated form-fittingly in the profiled receiving space of the main frame body. In addition, it can be advantageous if the insert is designed and arranged in the profiled receiving space of the main frame body in such a way that the insert does not protrude from the profiled receiving space. In this respect, the insert can be enclosed on three sides by the main frame body and sealed by same.

With such a modular flow frame, the sealing function and the fluid distributor function are distributed to different components—the main frame body and the insert—and thus decoupled from one another. A high degree of flexibility can be achieved thereby. In particular, such a modular construction makes it possible to produce flow frames with customized properties in a simple and at the same time cost-effective manner. By way of example, it is possible, by using different inserts, to adjust a flow profile through the frame opening—for example depending on an electrolyte used—as required without the main frame body having to be changed in its basic shape. This makes it possible, for example, to provide a uniform type of main frame body, into which different inserts can then be inserted, depending on the requirement.

Because the insert is formed separately from the main frame body, the main frame body and the insert can in particular be produced from different materials. This makes it possible to select individually advantageous materials for the respective functions of the main frame body or insert and combine them in a flow frame. For example, it is conceivable for the main frame body to be manufactured from a comparatively soft material in order to achieve a good sealing effect to adjacent components (for example to the membrane, bipolar plate or further flow frames when used in a cell stack), while the insert is produced from a comparatively hard material in order to provide sufficient mechanical dimensional stability of the channel structures, which is required for a reliable electrolyte flow.

A flow frame constructed in a modular manner from the main frame body and the insert can also be produced in a simple and cost-effective manner. Because no fluid distributor structures have to be integrated in the main frame body, the main frame body can be produced from profiled elements that are comparatively simple and thus inexpensive to produce. For this purpose, it is particularly advantageous if the cross-sectional profile of the main frame body is extrudable, i.e., is designed such that the cross-sectional profile can be produced by means of extrusion methods.

Preferably, the cross-sectional profile is substantially U-shaped. The cross-sectional profile then comprises in particular two long legs and a short leg. The long legs can be of the same or different length. Within the meaning of the invention, U-shaped does not mean that the main frame body cannot have local recesses and/or projections on its outer side when viewed in cross section.

In a preferred embodiment, the main frame body can comprise a plurality of extruded profiled parts. This makes it possible to produce main frame bodies of different sizes and geometries in a simple and cost-effective manner and thus to realize redox flow cells with different active effective areas and thus power. Only the insert with the electrolyte distribution structures has to be varied and adapted accordingly. The profiled parts have in particular a cross-sectional profile open on one side, so that a profiled part receiving space is formed in each case. The profiled part receiving spaces of the profiled parts then provide the profiled receiving space of the main frame body. Preferably, the extruded profiled parts already have the desired cross-sectional profile of the main frame body, for example a substantially U-shaped cross-sectional profile. In principle, however, it is also conceivable for the profiled parts to be composed of multiple extruded profiled segments of a different geometry, e.g. L-profiles.

In particular, at least a subset, but preferably all of the profiled parts of the main frame body have the same cross-sectional profile. In this respect, the individual profiled parts are preferably identical in their basic shape and differ only in their length. In such an embodiment, it is possible in particular to produce the profiled parts by means of the same extrusion die, for example by cutting a corresponding continuous extrudate to length.

The main frame body can be composed of a plurality of profiled parts. The profiled parts are preferably connected to one another at their ends to form the main frame body. The profiled part receiving spaces of the profiled parts then together form a profiled receiving space of the main frame body that runs all the way around the frame opening. For example, a main frame body with a rectangular basic shape can be composed of two short profiled parts and two long profiled parts.

It is also possible for the profiled parts to be connected to one another via connecting parts. In particular, the main frame body can comprise two profiled parts and two connecting parts connecting the profiled parts to one another. The connecting parts are then in particular designed and arranged between the profiled parts such that they engage, in particular form-fittingly, with a respective end portion in the profiled receiving part spaces of the profiled parts. In this respect, the connecting parts together with the profiled parts form the main frame body. The connecting parts are in particular not completely accommodated in the profiled part receiving spaces, but rather themselves form part of the structure directly delimiting the frame opening with a central portion. The connecting parts and the profiled parts are in particular designed separately insofar as the profiled parts and the connecting parts are provided as separate elements and are joined together to assemble the flow frame. For a secure connection, it can also be advantageous if the connecting parts have connecting contours at their end portions, for example in the form of connecting pins. The profiled elements can then have corresponding mating connecting contours, for example in the form of corresponding cut-outs, into which the connecting contours engage in the assembled configuration. The connecting parts can be produced, for example, by means of extrusion processes or injection molding methods. In one embodiment with connecting parts, the insert comprises in particular multiple separate insert parts, wherein in each case one insert part is arranged in each profiled part receiving space of the two profiled parts.

Preferably, the profiled parts are connected fluid-tightly to one another. For this purpose, it can be advantageous in one embodiment of the main frame body without connecting parts if the profiled parts are miter-cut at their ends and are integrally bonded to one another, for example by means of gluing and/or welding. In one embodiment of the main frame body with connecting parts, the profiled parts can be connected fluid-tightly to one another via the connecting parts. Preferably, the connecting parts are integrally bonded to the profiled parts, for example by welding and/or gluing. Because the connecting parts engage in the profiled receiving spaces of the profiled parts, a comparatively large connecting surface is provided, which promotes reliable sealing.

The channel structures of the insert can run inside the insert. In this respect, the channel structures can be formed internally, i.e., enclosed by insert material. However, it is preferred if the channel structures of the insert are formed by recesses on the outer side of the insert. In this respect, the channel structures are preferably formed on the outside on a surface of the insert. Such external channel structures can be produced comparatively easily, for example by removing the outer side of the insert or by embossing methods. In such an embodiment, the channel structures are then open on one side. In particular, when the insert is installed as intended in the main frame body, the external channel structures are then closed by an inner wall of the main frame body, so that closed fluid channels are formed in cooperation with the main frame body.

In this context, it can also be advantageous if the insert has sealing contours on its outer surface for sealing against the main frame body. Preferably, sealing contours are provided for sealing the, in particular external, channel structures of the insert. For this purpose, the sealing contours can in particular be arranged such that they enclose a channel structure between them, in particular follow a course of the channel structure. An advantageous embodiment of the sealing contours can consist in particular in that the insert has at least one, in particular surrounding, projection on its outer side. When the insert is arranged as intended in the profiled receiving space, the at least one projection of the insert can then dig into the preferably softer main frame body and thus provide a sealing effect. Alternatively or additionally, it is also possible for the main frame body to have corresponding counter sealing contours. For example, the main frame body can have, on its inner wall facing the profiled receiving space, at least one corresponding, in particular surrounding, groove into which the at least one projection of the insert engages when the insert is arranged in the profiled receiving space as intended. Of course, it is also possible for the insert to have the at least one groove and the main frame body to have the at least one projection.

In order to achieve a good sealing effect between the insert and the main frame body and between adjacent main frame bodies, for example when the flow frame is used in a cell stack, it can also be advantageous if the main frame body is produced from, in particular consists of, an elastomer which is chemically resistant to the electrolyte. In one embodiment of the main frame body consisting of profiled parts, it is particularly preferred for the profiled parts to be produced from an elastomer that is chemically resistant to the electrolyte and at the same time extrudable. Preferably, the main frame body or the profiled parts are produced from a thermoplastic elastomer, in particular thermoplastic polyethylene (TPE), thermoplastic polystyrene (TPS), thermoplastic polyurethane (TPU), a thermoplastic vulcanizate (TPV) or combinations of these materials.

It is particularly advantageous if the elastomer from which the main frame body or the profiled parts are produced has a Shore hardness in the range from 40 to 90 Shore A, preferably in the range from 50 to 80 Shore A. Such an elastomer is soft enough to achieve a good seal between the main frame body and adjacent components (e.g., insert, bipolar plate, membrane, etc.) but still sufficiently mechanically loadable, for example, to provide sufficient dimensional stability during subsequent pressing of the main frame body in a cell stack.

The insert is produced in particular from a different material than the main frame body. Preferably, the insert is produced from a plastic that is harder and/or stiffer than the main frame body material. Due to the combination of softer main frame body material and harder insert material, a good seal between the two components can be achieved, for example, via sealing contours described above. In addition, the formation of the insert from a comparatively hard material can ensure that a cross section of the channel structures of the insert is not changed or only slightly changed when the flow frame is pressed in a cell stack. As a result, a reliable fluid flow can be ensured. The insert is preferably produced from a thermoplastic material, in particular polypropylene (PP), polyethylene (PE) and/or polyvinyl chloride (PVC). The inserts can be produced in a simple manner mechanically, for example by milling or in the case of larger quantities, by means of an inexpensive injection molding process.

The insert can be formed in one piece, in particular monolithically, for example in the form of an insertion frame. This enables simple handling of the insert during assembly of the flow frame.

However, the insert can also be formed in multiple parts. In particular, the insert can comprise at least two, preferably two or four, separately formed insert parts. The insert parts can then be inserted in a simple manner separately into the profiled receiving space of the main frame body or into the profiled part receiving spaces of the profiled parts. A multi-part configuration of the insert makes it possible to flexibly adapt an electrolyte distribution in the effective space to different requirements (e.g., depending on the electrolyte used or depending on a size and geometry of the main frame body, etc.) in a simple manner. By way of example, a flow profile of the electrolyte liquid in the effective space can be set individually by specific arrangement and configuration of the insert parts. In particular, it is conceivable for a set of standard insert parts to be provided, which can then be flexibly combined depending on the requirement. Such a modular construction of standard components is particularly cost-efficient. In principle, it is conceivable, for example, for insert parts with different channel structures to be provided at different positions around the frame opening. It is also conceivable for only a subset of the insert parts to have channel structures at all. In particular, the insert parts can have different geometries, for example rectangular, L-shaped, or trapezoidal basic shapes. It is also possible for the insert parts to have differently shaped channel structures.

In an embodiment of the main frame body with a rectangular basic shape, it can be advantageous, in particular, if, preferably only, the insert parts that are arranged on the long sides of the main frame body have channel structures for distributing the fluid in the frame opening. The electrolyte then only has to cover a comparatively short flow path through an electrode arranged in the frame opening (namely along the short sides of the flow frame), and therefore the pressure drop when flowing through the electrode is low.

When arranged as intended in the main frame body, the insert parts are preferably connected fluid-tightly to one another. For this purpose, the insert parts can be connected to one another to form an insertion frame, in particular in an integrally bonded and/or form-fitting manner, for example by means of tongue and groove connections.

In an advantageous development of the flow frame, the flow frame can have a receiving region for receiving a bipolar plate (bipolar plate receiving region) and/or have a receiving region for receiving a membrane (membrane receiving region). When the flow frame is used in a cell or a cell stack, a membrane or a bipolar plate can then be arranged in the respective receiving region. The receiving regions thereby enable a simple positioning of the bipolar plate or membrane and at the same time promote a secure, positionally accurate mounting of the membrane or bipolar plate. In particular, a bipolar plate receiving region and a membrane receiving region are formed on opposite outer sides of the flow frame.

A preferred embodiment consists in that the respective receiving region is formed by a recess on an outer side of the main frame body. In particular, the main frame body can have, at least on one of the outer sides that are oriented parallel to a frame plane spanned by the frame opening, a recess adjacent to the frame opening and running around said frame opening. Preferably, the recess has a stepped cross section as viewed in the circumferential direction. In this respect, the main frame body has, in particular, an edge which extends orthogonally to the frame plane, runs around the frame opening, and forms a stop for the bipolar plate or the membrane. A recess forming the bipolar plate receiving region and a recess forming the membrane receiving region are arranged in particular on opposite outer sides of the main frame body.

If the main frame body is composed of multiple profiled parts, the profiled parts can in this respect have a stepped recess at least on one of the outer sides that are oriented orthogonally to the open side, in particular on both opposite outer sides, said recess extending along the entire longitudinal extension of the profiled parts. Such a profiled part is then extrudable in this respect.

In order to seal a bipolar plate arranged in the bipolar plate receiving region or to seal a membrane arranged in the membrane receiving region, it can also be advantageous if the main frame body has surrounding sealing lips for fluid-tight sealing of an overlying bipolar plate and/or membrane.

In order to seal flow frames arranged next to one another, for example when used in a cell stack, it can also be advantageous for the main frame body to have a groove running around the frame opening on one of the outer sides that are oriented parallel to a frame plane spanned by the frame opening and to have a corresponding projection running around the frame opening on the opposite outer side. In this respect, the frame body is in particular designed in such a way that flow frames arranged next to one another can be connected to one another, in particular fluid-tightly, in the manner of a tongue and groove.

If the main frame body is composed of multiple profiled parts, the individual profiled parts can in this respect have a groove extending along their longitudinal extension, in particular from their respective first end to the second end, on one of the outer sides that are oriented orthogonally to the open side, and have a corresponding projection on their opposite outer side. Such a profiled part is extrudable in this respect.

In order to solve the problem mentioned at the outset, a flow frame electrode unit is also proposed, which in particular comprises a flow frame described above and an electrode. Preferably, the electrode is arranged within the frame opening, that is, in particular defined by the flow frame. In particular, the electrode is designed and arranged such that it completely fills the frame opening. The electrode can in particular be a felt electrode, preferably consisting of a carbon material, for example of a graphite felt.

In an advantageous embodiment, the electrode can in particular be designed and arranged such that the electrode is adjoined flush with the inner edges of the main frame body facing the frame opening. In such an embodiment, the profiled receiving space is closed at its open side by the electrode. An electrolyte liquid flowing via the channel structures of the insert in the direction of the frame opening can then be received directly by the electrode and reduced or oxidized therein.

In an alternative advantageous embodiment, the electrode can also be designed and arranged in such a way that the electrode penetrates partially into the profiled receiving space of the main frame body. A penetration depth is preferably 1 to 5 mm. As a result, it can be ensured in particular that an electrolyte liquid flowing out of the channel structures of the insert impinges on the electrode first, so that any electrical potential differences present between the electrolyte and the cell can be dissipated there. For this purpose, it can also be advantageous if the electrode is accommodated in the profiled receiving space form-fittingly.

Furthermore, a cell for a redox flow battery is proposed, which comprises a first and a second flow frame electrode unit explained above. The cell also comprises a membrane which is arranged between the first and the second flow frame electrode unit. The flow frame electrode units in particular each form a half-cell of the cell. The membrane allows ion exchange between the half-cells. For this purpose, the membrane is ion-conducting, in particular produced from an ion-conducting material. The membrane is preferably accommodated in a membrane receiving region of the flow frame described above.

In an advantageous embodiment of such a cell, the two flow frames can be of identical design. Then, the flow frame of the second flow frame electrode unit can, in particular, be pivoted by 180° about one of its outer edges relative to the flow frame of the first flow frame electrode unit. In such a configuration, only one flow frame type is required for the construction of a cell, which enables a particularly cost-efficient production of the cell.

For use in a redox flow battery, it can be particularly advantageous if a plurality of the cells described above are stacked to form a cell stack. In this respect, a cell stack which comprises a plurality of the cells described above is also proposed to achieve the object. The cells are stacked on top of one another in particular in a stacking direction orthogonal to the frame plane spanned by the flow frame. A bipolar plate is arranged in each case between adjacent cells. In this respect, each bipolar plate is assigned to two adjacent half-cells. The bipolar plates are preferably arranged in the above-described bipolar plate receiving regions.

In particular, each bipolar plate completely covers the frame opening of the adjacent flow frames. In order to achieve a good seal between the flow frame and the bipolar plate or between the flow frame and the membrane, it can be advantageous, in particular, if the bipolar plates and/or the membranes are designed and arranged such that they, when viewed in the stacking direction, partially overlap with the respective insert of the adjacent flow frame electrode units in a direction orthogonal to the stacking direction. In this respect, the bipolar plate and/or the membrane in particular extend radially beyond the frame opening in such a way that, when viewed in the stacking direction, they partially overlap the insert of the adjacent flow frame. When the components are pressed in the cell stack, the bipolar plate and membrane are then supported by the insert. As a result, a homogeneous force distribution can be achieved, which facilitates good sealing between the individual components of a cell stack, in particular between the bipolar plate, the main frame body, the insert and the membrane. An overlap between the bipolar plate and the insert or between the membrane and the insert is preferably 1 to 40 mm, in particular 5 to 15 mm.

A further advantageous development of the cell stack can consist in that each flow frame is connected fluid-tightly to the further flow frame belonging to the same cell and/or to the flow frame of an adjacent cell. In particular, the flow frames can be connected to one another and sealed against one another via the tongue and groove connection described above. In principle, however, it is also possible for the individual flow frames to be joined fluid-tightly on the surrounding surfaces, for example by means of welding and/or gluing. By means of additional sealing lips, the surface forces for pressing the components of the cell stack (main frame body, insert, membrane, bipolar plate, etc.) to one another can be reduced.

The object stated at the outset is also achieved by the use of a flow frame described above in a redox flow battery, in particular in a cell of a redox flow battery. As already explained, the modular construction of the flow frame makes it possible to realize redox flow batteries with different active effective areas and thus power in a simple and cost-effective manner. In addition, reference is made to the features and advantages explained above in connection with the flow frame.

In order to produce a flow frame described above, a method which comprises the following steps is proposed in particular. The features and advantages explained above in connection with the flow frame as such can serve to form the method.

According to the method, a plurality of profiled parts is provided. For this purpose, in particular an extrudate is extruded which has a preferably substantially U-shaped cross-sectional profile which is open on one side so that a profiled part receiving space which is open on one side is formed. The extrudate is then cut to length according to a desired size of the subsequent flow frame to form the profiled parts.

Optionally, fluid channel structures can be produced in at least a subset of the profiled parts. For this purpose, in particular locally defined cut-outs can be produced in the corresponding profiled parts, preferably by drilling or punching.

For further assembly, it can be advantageous if the profiled parts are inserted into an assembly device. The assembly device is in particular designed such that it defines a rectangular receiving space, the inner perimeter of which substantially corresponds to the outer dimensions of the subsequent main frame body.

In a further method step, the profiled parts are connected fluid-tightly, in particular in an integrally bonded manner, at connecting portions to form the main frame body. For this purpose, connecting contours can be produced, for example by cutting out or punching out, at the respective ends, in particular at the end faces, of the profiled parts, after cutting to length. In an advantageous embodiment, the profiled parts can initially be miter-cut at the respective end faces and then connected to one another at their end faces by welding and/or gluing. The profiled parts can also be connected to one another via connecting parts described above. Then, the profiled parts and the connecting parts are mechanically joined first and then integrally bonded to one another.

According to the method, an insert or a plurality of insert parts is also provided and inserted into the profiled receiving spaces of the profiled parts.

According to an advantageous embodiment of the method, the insert or the insert parts can be inserted into the profiled part receiving spaces of the individual profiled parts before the profiled parts are connected to form the main frame body. However, it is also possible for the insert or the insert parts to be inserted into the profiled receiving space of the main frame body only after the profiled parts have been connected to form the main frame body.

In an optional further method step, the insert or the insert parts can be connected to the profiled parts, in particular in an integrally bonded manner, preferably in the course of connecting the profiled parts to form the main frame body.

The invention is explained in more detail below with reference to the drawings.

In the drawings:

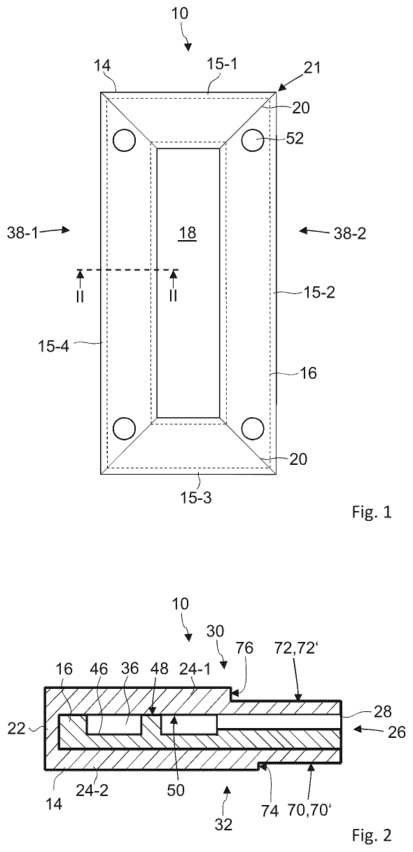

FIG. 1 shows a sketch of an embodiment of a flow frame in a view from above;

FIG. 2 shows a sketch of the flow frame according to FIG. 1 in a sectional view along the sectional plane II-II shown in FIG. 1;

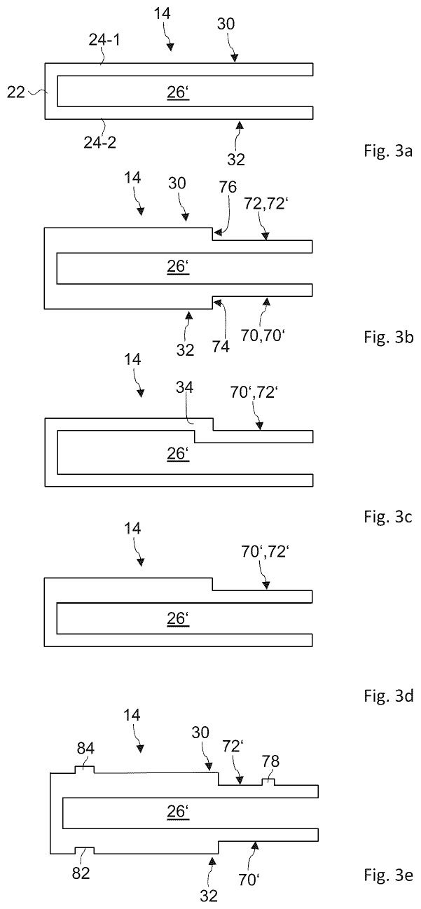

FIGS. 3a-e show sketches of different embodiments of a main frame body in a sectional view corresponding to the sectional plane II-II shown in FIG. 1;

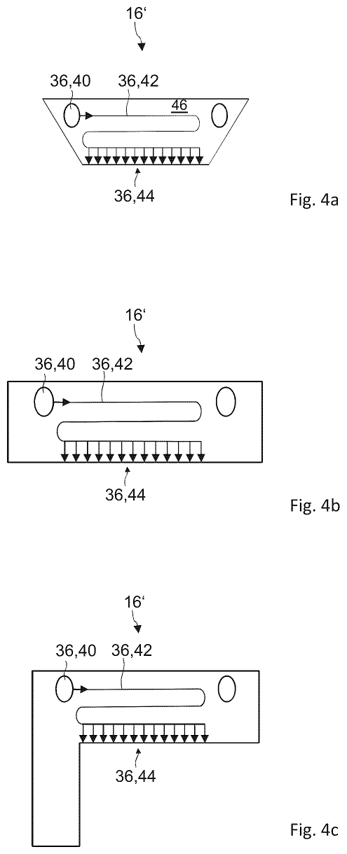

FIGS. 4a-c show sketches of different embodiments of an insert part in a view from above;

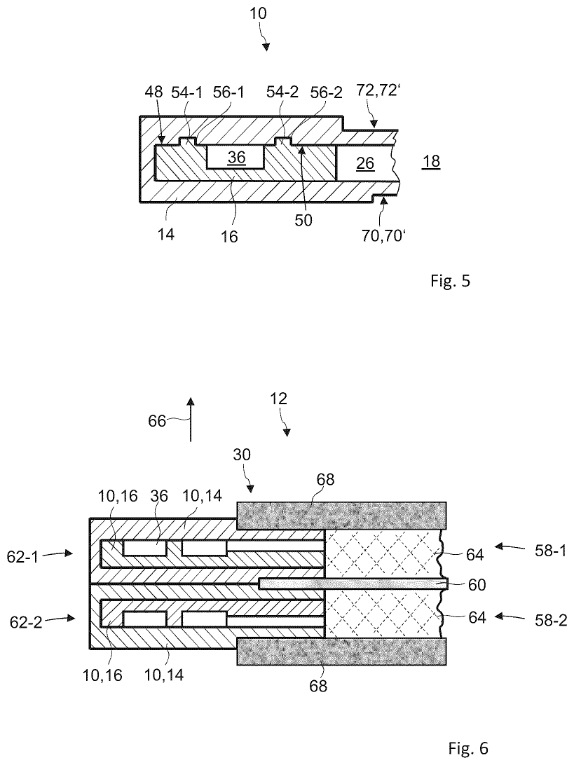

FIG. 5 shows a sketch of a further embodiment of a flow frame in a sectional view corresponding to the sectional plane II-II shown in FIG. 1;

FIG. 6 shows a sketch of a detail of a redox flow cell in a sectional view along a sectional plane corresponding to the sectional plane II-II shown in FIG. 1;

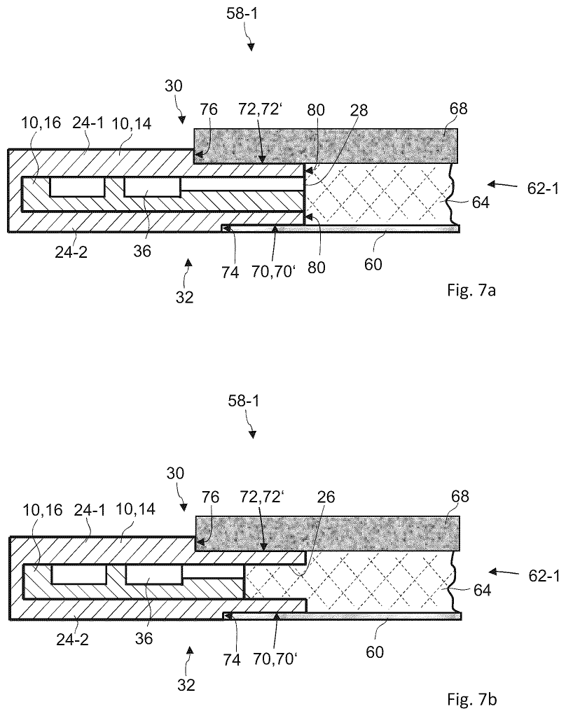

FIGS. 7a-b show sketches of two embodiments of a half-cell;

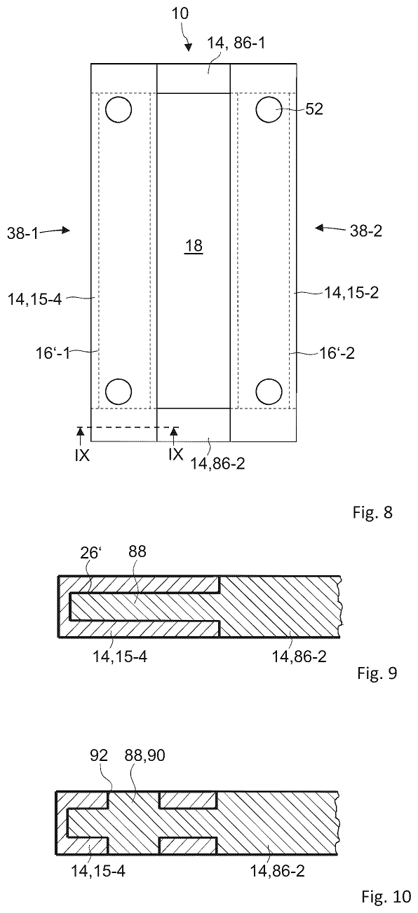

FIG. 8 shows a sketch of a further embodiment of a flow frame in a view from above;

FIG. 9 shows a sketch of the flow frame according to FIG. 8 in a sectional view along the sectional plane IX-IX shown in FIG. 8; and

FIG. 10 shows a sketch of a further embodiment of the flow frame in a view corresponding to FIG. 9.

In the following description and in the figures, the same reference signs are used for identical or corresponding features.

FIG. 1 shows an embodiment of a flow frame, which is denoted as a whole by reference sign 10. The flow frame 10 is designed in particular for use in a redox flow cell 12, which is described in detail below and is partially shown in FIG. 6.

The flow frame 10 is of modular construction and comprises a main frame body 14 and an insert 16 (shown in FIG. 1 with dashed lines) arranged in the main frame body 14.

As can be seen in FIG. 1, the main frame body 14 surrounds a central frame opening 18, which defines the actual effective space of the cell 12 (explained in more detail below). The main frame body 14 is composed of a plurality, four in the example shown, of profiled parts 15-1, 15-2, 15-3, 15-4. The profiled parts 15-1, 15-2, 15-3, 15-4 are produced by way of example and preferably by means of extrusion methods (see below). In the example shown, the main frame body 14 and the frame opening 18 each have a rectangular basic shape. In this respect, two long profiled parts 15-2, 15-4 and two short profiled parts 15-1, 15-3 are provided. However, other polygonal geometries are also conceivable in embodiments not shown.

As can be seen in FIG. 1, the profiled parts 15-1, 15-2, 15-3, 15-4 are for example miter-cut at their respective ends 20 and are connected to form the main frame body 14. By way of example and preferably, the profiled parts 15-1, 15-3, 15-4 are connected to one another fluid-tightly, for example by means of gluing and/or welding.

As can be seen in FIG. 2, the profiled parts 15-1, 15-2, 15-3, 15-4 and thus the main frame body 14 composed thereof have a cross-sectional profile which is open on one side in the direction of the frame opening 18 when viewed in the circumferential direction about the frame opening 18. In the example shown, the cross-sectional profile is substantially U-shaped with a short leg 22 and two long legs 24-1, 24-2.

As can be seen in FIGS. 2 and 3a to 3e, the profiled parts 15-1, 15-2, 15-3, 15-4 each delimit an inner profiled part receiving space 26′ which is open on one side by means of a profiled opening 28. If the profiled parts 15-1, 15-2, 15-3, 15-4 are assembled to form the main frame body 14, a profiled receiving space 26 is formed that runs around the frame opening 18 and is open in the direction of the frame opening 18.

FIGS. 3a to 3e show further exemplary cross-sectional profiles that the main frame body 14 can have. The main frame body 14 can thus be designed, for example, mirror-symmetrically to a frame plane spanned by the frame opening 18 (cf. FIGS. 3a and 3b). It is also possible for the main frame body 14 to have recesses 70′, 72′, 82 or projections 78, 84 on its outer sides 30, 32 oriented orthogonally to the frame plane (cf. FIGS. 3b to 3e, described in detail below). As shown in FIG. 3c, the profiled part receiving space 26′ can also have an internal step 34.

The main frame body 14 is produced by way of example and preferably from a thermoplastic elastomer with a Shore hardness of 50 to 80 Shore A.

As can be seen in FIG. 2, the aforementioned insert 16 is arranged in the profiled receiving space 26 of the main frame body 14. The insert 16 is formed separately from the main frame body 14 and is inserted into the profiled receiving space 26 in order to assemble the flow frame 10 (explained in more detail below with respect to the production method).

By way of example and preferably, the insert 16 is produced from a stiffer material than the main frame body 14, in particular from polypropylene (PP), polyethylene (PE) and/or polyvinyl chloride (PVC).

As can be seen in FIG. 1, the insert 16 is designed by way of example in such a way that it runs all the way around the frame opening 18. In the example shown, the insert 16 is moreover dimensioned such that it does not protrude from the profiled receiving space 26 and is accommodated form-fittingly in the profiled receiving space 26 (cf. FIG. 2).

As shown in FIG. 2, the insert 16 comprises channel structures 36, which are designed to distribute electrolyte liquid in the frame opening 18 and are explained in more detail below. The insert 16 can be designed such that channel structures 36 are provided along its entire perimeter. By way of example and preferably, the channel structures 36 are however arranged only on the long sides 38-1, 38-2 of the flow frame 10.

The insert 16 can be formed in one piece, for example in the form of an insertion frame (shown by way of example in FIG. 1). In an alternative embodiment, the insert 16 can also be formed from a plurality of insert parts 16′ provided separately. These can be inserted separately from one another into the profiled receiving space 26 and can optionally be connected to one another fluid-tightly, in particular in an integrally bonded manner.

The insert parts 16′ can in principle be configured differently. A selection of exemplary embodiments of the insert parts 16′ is shown in FIGS. 4a to 4c. For example, the insert parts 16′ can have a trapezoidal (cf. FIG. 4a) or rectangular (cf. FIG. 4b) or L-shaped (cf. FIG. 4c) basic shape. Depending on the requirement, different insert parts 16′ can be used and combined with one another.

The insert parts 16′ shown in FIGS. 4a to 4c each comprise aforementioned channel structures 36. In embodiments not shown, insert parts 16′ can however also be free of channel structures 36. In the example shown, the channel structures 36 comprise a fluid connection 40, a fluid guide 42, of serpentine shape in the example shown, and comb-shaped distributor structures 44 which open into the frame opening 18 when the insert parts 16′ are installed as intended. This configuration of the channel structures 36, 40, 42, 44, which is only shown by way of example in the figures for the insert parts 16′, can also be provided in a corresponding manner in the case of a one-piece design of the insert 16.

The channel structures 36, 40, 42, 44 are formed by way of example and preferably by corresponding recesses 46 on an outer side 48 of the insert 16 or of the insert parts 16′ (cf. FIG. 2). When the insert 16 or the insert parts 16′ are installed as intended in the profiled receiving space 26, the channel structures 36, 40, 42, 44 are then closed by an inner wall 50 of the main frame body 14 (cf. FIG. 2). To feed the channel structures 36 with electrolyte liquid, the main frame body 14 has corresponding bores 52 in the example shown in FIG. 1, which bores are aligned with the fluid connections 40 of the insert 16 or the insert parts 16′ in the assembled state of the flow frame 10.

As shown by way of example in FIG. 5, to seal off the channel structures 36 and/or fluid passages 52, which are explained in more detail below, from the main frame body 14, the insert 16 or the insert parts 16′ can have optional projections 54-1, 54-2 on its outer side 48 such that a channel structure 36 to be sealed is enclosed between the projections 54-1, 54-2. When the insert 16 or the insert parts 16′ are installed as intended in the profiled receiving space 26, the projections 54-1, 54-2 of the insert 16 can then dig into the inner wall 50 of the softer main frame body 14 and thus provide a sealing effect. It is also possible for the main frame body 14 to have corresponding grooves 56-1, 56-2 on the inner wall 50 of the main frame body 14 facing the profiled receiving space 26, into which grooves the projections 54-1, 54-2 engage.

As already mentioned, a flow frame 10 described above serves in particular for use in a redox flow cell 12. A detail of a possible embodiment of such a cell 12 is sketched in FIG. 6. FIG. 6 shows the cell 12 in a sectional view along a sectional plane corresponding to the sectional plane II-II in FIG. 1.

The cell 12 comprises two half-cells 58-1, 58-2, between which a membrane 60 is arranged. Each half-cell 58-1, 58-2 comprises a flow frame electrode unit 62-1, 62-2, which in turn comprises a flow frame 10 and an electrode 64 arranged in the frame opening 18 of the flow frame 10 (described in detail below with respect to FIGS. 7a and 7b). As can be seen in FIG. 6, in the example shown, the flow frames 10 of the two flow frame electrode units 62-1, 62-2 are identical to one another but are pivoted relative to one another by 180° about the membrane plane. The membrane 60 is preferably designed and arranged such that the frame opening 18 and the electrode 64 arranged therein are covered by the membrane 60, in particular completely.

In a redox flow battery, a plurality of such cells 12 are preferably stacked on top of one another in a stacking direction 66 to form a cell stack (not shown) and pressed against one another by a bracing system (not shown). A bipolar plate 68, which electrically connects two adjacent cells 12, is then provided between the individual cells in such a cell stack. FIG. 6 shows, by way of example, two such bipolar plates 68, which are each arranged on the outer side 30, opposite the membrane 60, of the corresponding flow frame 10. Preferably, a bipolar plate 68 also completely covers the frame opening 18.

As can be seen in FIG. 7a, which shows a half-cell 58-1 of the cell 12 according to FIG. 6 in isolation, the membrane 60 in the example shown is accommodated in a membrane receiving region 70 which is formed on a first outer side 32 of the main frame body 14. Analogously, in the example shown, the bipolar plate 68 is also arranged in a corresponding bipolar plate receiving region 72, which is formed on the opposite outer side 30 of the main frame body 14.

Specifically, the membrane receiving region 70 and the bipolar plate receiving region 72 are formed by a recess 72′ of stepped cross section, on the outer sides 30, 32 of the main frame body 14 that are oriented parallel to a frame plane spanned by the frame opening 18 (cf. also FIG. 2). In this case, the respective stepped recess 70′, 72′ is adjacent to the frame opening 18 and runs preferably all the way around it. As shown in FIGS. 7a and 2, the stepped recesses 70′, 72′ each form an edge 74 and 76, respectively, which extends orthogonally to the frame plane spanned by the frame opening 18 and forms a stop for the membrane 60 and the bipolar plate 68, respectively.

By way of example and preferably, the insert 16 and the membrane receiving region 70 or the bipolar plate receiving region 72 are matched to one another in such a way that a membrane 60 or bipolar plate 68 abutting the respective edge 74 or 76 partially overlaps with the insert 16 when viewed in the stacking direction 66 (cf. FIG. 7a).

As can be seen in FIGS. 3a to 3e, various embodiments of the main frame body 14 with respect to the receiving regions 70, 72 are conceivable in principle. The embodiments of the receiving regions 70, 72 or recesses 72′ shown in FIGS. 3a to 3e can be provided independently of the further embodiment features of the main frame body 14 (e.g., relative thickness of the legs 24-1, 24-2 or the presence of further contour elements such as projections 78, 84 or recesses 82) which are specifically shown in the relevant figures. In a first embodiment according to FIG. 3a, neither the membrane receiving region 70 nor the bipolar plate receiving region 72 are provided. The membrane 60 and bipolar plate 69 then bear in particular against the two flat outer sides 30, 32 of the main frame body 14. In a further embodiment according to FIG. 3b, a stepped recess 70 or 72′, i.e., both the membrane receiving region 70 and the bipolar plate receiving region 72, is provided on both outer sides 30, 32. It is also possible for a stepped recess 70′, 72′ to be provided only on one of the outer sides 30, 32, said recess then forming either the membrane receiving region 70 or the bipolar plate receiving region 72 (cf. FIGS. 3c and 3d). As shown by way of example in FIG. 3e for a recess 72′, a local projection 78 can additionally be provided within such a stepped recess 70′ or 72′, which local projection can in particular serve as a sealing lip and/or positioning aid. Such a projection 78 can be provided in the membrane receiving region 70 and/or in the bipolar plate receiving region 72.

Two exemplary embodiments of a flow frame electrode unit 62, which differ only in the specific design and arrangement of the electrode 64, are described below with reference to FIGS. 7a and 7b. In both cases, the electrode 64 is designed by way of example and preferably as a felt electrode, for example made of a graphite felt.

In the embodiment shown in FIG. 7a (corresponds to the embodiment shown in FIG. 6), the electrode 64 is designed and arranged such that it is adjoined flush with the inner edges 80 of the main frame body 14 facing the frame opening 18. As viewed in cross section, the electrode 64 is therefore adjoined flush with the free ends 80 of the two long legs 24-1, 24-2 of the main frame body 14. In this respect, the profiled opening 28 is closed by the electrode 64. In the example shown, the insert 16 is dimensioned such that it bears directly against the electrode 64.

In the embodiment according to FIG. 7b, the electrode 64 is designed and arranged in such a way that it penetrates partially into the profiled receiving space 26 of the main frame body 14 and is accommodated form-fittingly there. As can be seen in FIG. 7b, the insert 16 and the electrode 64 are also designed here in such a way that the electrode 64 bears directly against the insert 16.

To seal flow frames 10 arranged next to one another, for example when used in an aforementioned cell stack, the main frame bodies 14 of the flow frames 10 can be connected fluid-tightly to one another in the manner of a tongue and groove. FIG. 3e shows an exemplary embodiment of such a tongue-and-groove connection in cross section. In the example shown, the main frame body 14 has a groove 82 running around the frame opening 18 on a first outer side 32, and a corresponding projection 84 (tongue) running around the frame opening on the opposite outer side 30.

As shown by way of example in FIG. 8, the profiled parts 15-2, 15-4 can also be connected to one another via connecting elements 86-1, 86-2. In the example shown, the flow frame 14 is composed of two profiled parts 15-2, 15-4 and two connecting parts 86-1, 86-2. The connecting parts 86-1, 86-2 are arranged between the profiled parts 15-2, 15-4 and engage with a respective end portion 88 in the profiled receiving spaces 26′ of the profiled parts 15-2, 15-4 (shown by way of example for a connection point in FIG. 9a). By way of example and preferably, the connecting parts 86-1, 86-2 are integrally bonded to the profiled parts 15-2, 15-4. In the example shown in FIG. 8, in each case an insert part 16′-1, 16′-2 is arranged in the profiled receiving spaces 26′ of the two profiled parts 15-2, 15-4, said insert part preferably having channel structures 36 described above. For the further design of the profiled parts 15-2, 15-4 and of the insert parts 16′-1, 16′-2, reference is made to the embodiments described above.

As shown by way of example in FIG. 10, the connecting parts 86-1, 86-2 can additionally have connecting contours, for example in the form of connecting pins 90, at their end portions 88. The profiled parts 15-2, 15-4 then preferably each have corresponding cut-outs 92 in which the connecting pins 90 are form-fittingly received when the arrangement is as intended.

An embodiment of a method for producing the flow frame according to FIG. 1 is described below. According to the method, the profiled parts 15-1, 15-2, 15-3, 15-4 and the insert 16 or the insert parts 16′ are produced first.

To produce the profiled parts 15-1, 15-2, 15-3, 15-4, an extrudate having the desired cross-sectional profile (cf. FIGS. 3a to 3e) is first extruded and cut to length according to a desired size of the subsequent main frame body 14. To produce the flow frame 10 shown in FIG. 1, two short profiled parts 15-1, 15-3 and two long profiled parts 15-2, 15-4 are produced, for example.

Then, connecting contours 21 are produced at the respective ends 20 of the profiled parts 15-1, 15-2, 15-3, 15-4 (cf. FIG. 1). By way of example and preferably, the connecting contours 21 are produced by miter-cutting the profiled parts 15-1, 15-2, 15-3, 15-4 at their ends 20, for example by cutting or punching. In an optional further step, recesses 52 for electrolyte supply are produced, for example by drilling or punching, at least in a subset of the profiled parts 15-1, 15-2, 15-3, 15-4—to produce the embodiment shown in FIG. 1, in the long profiled parts 15-4.

The insert 16 or the insert parts 16′ are produced by way of example by primary forming, forming, separating or by injection molding.

The profiled parts 15-1, 15-2, 15-3, 15-4 and the insert 16 or the insert parts 16′ are then assembled to form the flow frame 10. For this purpose, first the insert 16 or the insert parts 16′ are inserted into the profiled part receiving spaces 26′ of the profiled parts 15-1, 15-2, 15-3, 15-4. In a further method step, the profiled parts 15-1, 15-3, 15-4 are then connected fluid-tightly, for example by welding and/or gluing, at their ends 20 to form the main frame body 14. Optionally, in the same working step, the insert parts 16′ can also be integrally bonded to one another and/or to the profiled parts 15-1, 15-2, 15-3, 15-4.

In an alternative embodiment of the method, it is also possible for the insert parts 16′ to be inserted into the profiled receiving space 26 only after the profiled parts 15-2, 15-3, 15-4 have been connected.

To produce the flow frame 10 shown in FIG. 8, two profiled parts 15-2, 15-4 and two insert parts 16′-1, 16′-2 are first produced in the manner described above. Furthermore, the connecting parts 86-1, 86-2 are produced, for example by means of an injection molding method. Then, to assemble the main frame body 14, the insert parts 16′-1, 16′-2 are first inserted into the profiled part receiving spaces 26′ of the profiled parts 15-2, 15-4, and then the profiled parts 15-2, 15-4 are joined together with the connecting parts 86-1, 86-2 and integrally bonded to one another.

1. A modular flow frame (10) for an electrochemical cell (12), in particular for a cell (12) of a redox flow battery, comprising
a main frame body (14) which defines a frame opening (18), the main frame body (14) having a substantially U-shaped cross-sectional profile which is open on one side in the direction of the frame opening (18), such that a profiled receiving space (26) open toward the frame opening (18) is formed;
an insert (16) which is arranged in the profiled receiving space (26) of the main frame body (14), the insert (16) having channel structures (36) for distributing fluids in the frame opening (18).

2. The modular flow frame (10) according to claim 1, wherein the main frame body (14) comprises a plurality of extruded profiled parts (15-1, 15-2, 15-3, 15-4), and the profiled parts (15-1, 15-2, 15-3, each delimit a profiled part receiving space (26′), including where the profiled parts (15-1, 15-2, 15-3, 15-4) have the same cross-sectional profile.

3. The modular flow frame (10) according to claim 2, wherein the main frame body (14) comprises two profiled parts (15-2, 15-4) and two connecting parts (86-1, 86-2) connecting the profiled parts (15-2, 15-4) to one another, and the connecting parts (86-1, 86-2) engage with a respective end portion (88) in the profiled part receiving spaces (26′) of the profiled parts (15-2, 15-4).

4. The modular flow frame (10) according to claim 2, wherein the profiled parts (15-1, 15-2, 15-3, 15-4) are connected to one another and/or the profiled parts (15-2, 15-3) are connected to the connecting parts (86-1, 86-2) fluid-tightly.

5. The modular flow frame (10) according to claim 1, wherein the channel structures (36, 40, 42, 44) of the insert (16) are formed by recesses (46) on the outer side (48) of the insert (16).

6. The modular flow frame (10) according to claim 1, wherein the insert (16) has, on its outer side (48), sealing contours (54-1, 54-2) for sealing the channel structures (36) against the main frame body (14), including where the main frame body (14) has corresponding counter sealing contours (56-1, 56-2).

7. The modular flow frame (10) according to claim 1, wherein the main frame body (14) is produced from an elastomer, including a thermoplastic elastomer, such as thermoplastic polyethylene (TPE), thermoplastic polystyrene (TPS), thermoplastic polyurethane (TPU) and/or a thermoplastic vulcanizate (TPV).

8. The modular flow frame (10) according to claim 1, wherein the insert (16) is produced from a plastic, which is harder and/or stiffer than the main frame body material, including a thermoplastic material, such as polypropylene (PP), polyethylene (PE) and/or polyvinyl chloride (PVC).

9. The modular flow frame (10) according to claim 1, wherein the insert (16) is formed in multiple parts, comprising at least two insert parts (16′), including where the insert parts (16′) are connected to form an insert frame in an integrally bonded and/or form-fitting manner, preferably via tongue and groove connections.

10. The modular flow frame (10) according to claim 8, wherein the main frame body (14) has a rectangular basic shape, and the insert parts (16′) that are arranged on the long sides (38-1, 38-2) of the main frame body (14) have channel structures (36) for distributing a fluid in the frame opening (18).

11. The modular flow frame (10) according to claim 1, wherein the main frame body (14) has, at least on one of the outer sides (30, 32) that are oriented parallel to a frame plane spanned by the frame opening 18, including on both opposite outer sides (30, 32), a stepped recess (70′, 72′) adjacent to the frame opening 18 and running around said frame opening.

12. A flow frame electrode unit (62-1, 62-2) comprising the flow frame (10) according to claim 1, and an electrode (64), configured to fill the frame opening (18), wherein either the electrode (64) is designed and arranged such that the electrode (64) is adjoined flush with the inner edges (80) of the main frame body (14) facing the frame opening (18), or the electrode (64) is designed and arranged such that the electrode (64) penetrates partially into the profiled receiving space (26) of the main frame body (14).

13. A cell (12) for a redox flow battery comprising a first and a second flow frame electrode unit (62-1, 62-2) according to claim 12, wherein a membrane (60) is arranged between the first and the second flow frame electrode unit (62-1, 62-2), including where the flow frame (10) of the second flow frame electrode unit (62-2) is pivoted by 180° about one of its outer edges relative to the flow frame (10) of the first flow frame electrode unit (62-1).

14. A cell stack for a redox flow battery, comprising a plurality of cells (12) according to claim 13, wherein the cells (12) are stacked on top of one another in a stacking direction (66), including where a bipolar plate (68) is arranged in each case between adjacent cells (12), and wherein the bipolar plates (68) and/or the membranes (60) are designed and arranged such that, when viewed in the stacking direction (66), they partially overlap with the respective insert (16) of the adjacent flow frame electrode units (62-1, 62-2) in a direction orthogonal to the stacking direction (66), in particular wherein an overlap is 1 to 40 mm, preferably 5 to 15 mm.

15. A method for producing the flow frame (10) according to claim 1, comprising the following steps:
a) providing a plurality of profiled parts (15-1, 15-2, 15-3, 15-4), wherein an extrudate is extruded, which has a preferably substantially U-shaped cross-sectional profile that is open on one side, so that a profiled part receiving space (26′) that is open on one side is formed, and wherein the extrudate is cut to length to form the profiled parts (15-1, 15-2, 15-3, 15-4);
b) inserting the insert (16) or the insert parts (16′) into the profiled part receiving spaces (26′) of the profiled parts (15-1, 15-2, 15-3, 15-4);
c) Fluid-tightly connecting, in particular integrally bonding, the profiled parts (15-1, 15-2, 15-3, 15-4) at connecting portions (21, 88, 90, 92).

16. The modular flow frame (10) according to claim 3, wherein the profiled parts (15-1, 15-2, 15-3, 15-4) are connected to one another and/or the profiled parts (15-2, 15-3) are connected to the connecting parts (86-1, 86-2) fluid-tightly.

17. The modular flow frame (10) according to claim 2, wherein the channel structures (36, 40, 42, 44) of the insert (16) are formed by recesses (46) on the outer side (48) of the insert (16).

18. The modular flow frame (10) according to claim 2, wherein the insert (16) has, on its outer side (48), sealing contours (54-1, 54-2) for sealing the channel structures (36) against the main frame body (14), including where the main frame body (14) has corresponding counter sealing contours (56-1, 56-2).

19. The modular flow frame (10) according to claim 2, wherein the main frame body (14) is produced from an elastomer, including a thermoplastic elastomer, such as thermoplastic polyethylene (TPE), thermoplastic polystyrene (TPS), thermoplastic polyurethane (TPU) and/or a thermoplastic vulcanizate (TPV).

20. The modular flow frame (10) according to claim 2, wherein the insert (16) is produced from a plastic, which is harder and/or stiffer than the main frame body material, including a thermoplastic material, such as polypropylene (PP), polyethylene (PE) and/or polyvinyl chloride (PVC).
